(19) United States
(12) Patent Application Publication
(10) Pub. No.: US 2020/0307489 A1
(43) Pub. Date: Oct. 1, 2020

(54) SEAT ASSEMBLY WITH FULL SEATBACK AIRBAG

(71) Applicant: Ford Global Technologies, LLC, Dearborn, MI (US)

(72) Inventors: Johnathan Andrew Line, Northville, MI (US); Marcos Silva Kondrad, Macomb Township, MI (US); Alan George Dry, Grosse Pointe Woods, MI (US); S. M. Akbar Berry, Windsor (CA); Derek Board, Ferndale, MI (US); Srinivasan Sundararajan, Ann Arbor, MI (US); Spencer Robert Hoernke, Dundas (CA)

(73) Assignee: Ford Global Technologies, LLC

(21) Appl. No.: 16/370,617

(22) Filed: Mar. 29, 2019

(51) Int. Cl. B60R 21/207; B60R 21/215; B60N 2/68; B60R 21/231

(52) U.S. Cl. CPC B60R 21/207; B60R 21/215; B60R 2021/23146; B60R 21/23184; B60N 2205/30; B60N 2/68

(57) ABSTRACT

A seatback assembly includes a seatback frame having first and second side members defining a back support portion of the seatback frame. An upper frame member interconnects the first and second side members of the seatback frame to define a headrest support portion of the seatback frame. The seatback frame includes an outer perimeter disposed around the first and second side members and the upper frame member. A front carrier module is operably coupled to a rear carrier module is operably around the seatback frame. The outer perimeter of the seatback frame is inset from a front edge of the rear carrier module to define a raceway therebetween. An airbag assembly is received in the raceway for outward deployment therefrom. The airbag assembly is an elongate member disposed on opposed sides of the back support portion of the seatback frame and over the headrest support portion of the seatback frame.

### FIELD OF THE INVENTION

The present invention generally relates to a seat assembly, and more particularly, to a seat assembly having a seatback carrier configuration supporting an airbag assembly for deploying a full seat airbag.

### BACKGROUND OF THE INVENTION

With the growing focus on autonomous or self-driving vehicles, new and flexible interior experiences are sought. With specific regard to seat assemblies, enhancements in occupant protection are needed as consumers rely less on seat belts and more on airbag systems and seat designs for protection. This is particularly the case in seating assemblies for autonomous vehicles which may be operable between various configurations, such as forward and rearward facing orientations. With such configurable arrangements, consistent protection is desired without regard to a specific orientation, i.e. rearward or forward facing orientation, of a seat assembly. The present concept provides an overhead airbag system for a seatback that packages within a thinner profile for a seat design and provides traditional restraint needs in an unconventional way to optimize safety, comfort and familiarity.

### SUMMARY OF THE INVENTION

According to one aspect of the present invention, a seatback assembly includes a seatback frame having first and second side members defining a back support portion of the seatback frame. An upper frame member interconnects the first and second side members of the seatback frame to define a headrest support portion of the seatback frame. The seatback frame includes an outer perimeter disposed around the first and second side members and the upper frame member. A front carrier module is operably coupled to a rear carrier module is operably around the seatback frame. The outer perimeter of the seatback frame is inset from a front edge of the rear carrier module to define a raceway therebetween. An airbag assembly is received in the raceway for outward deployment therefrom. The airbag assembly is an elongate member disposed on opposed sides of the back support portion of the seatback frame and over the headrest support portion of the seatback frame.

According to another aspect of the present invention, a seatback assembly includes a seatback frame that has an upper portion and an outer perimeter. A rear carrier module is operably coupled to the seatback frame. The rear carrier module includes a front edge outwardly spaced-apart from the outer perimeter of the seatback frame and surrounding the outer perimeter of the seatback frame to define a raceway. An airbag assembly is received in the raceway. The airbag assembly is an elongate airbag assembly having first and second ends with a body portion disposed between the first and second ends. The body portion of the airbag assembly is positioned over the upper portion of the seatback frame.

According to yet another aspect of the present invention, a seatback assembly includes a seatback frame having an outer perimeter. A front carrier module is operably coupled to the seatback frame and includes a rear edge. A rear carrier module is operably coupled to the seatback frame and includes a front edge. The rear carrier module and the front carrier module are detachably coupled to one another at the respective front and rear edges. The outer perimeter of the seatback frame is inset from the respective front and rear edges of the rear carrier module and the front carrier module to define a raceway. An airbag assembly is received in the raceway for outward deployment through a seam defined along a junction of the respective front and rear edges of the rear carrier module and the front carrier module.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a front perspective view of a seat assembly disposed within a vehicle interior;

FIG. 2 is a front perspective view of the seat assembly of FIG. 1 as removed from the vehicle interior;

FIG. 3 is a front perspective view of a seatback frame;

FIG. 4 is a front perspective view of a rear carrier module;

FIG. 5 is a front perspective view of the seat assembly of FIG. 2 with a front carrier module removed therefrom to reveal the rear carrier module and the seatback frame;

FIG. 6 is a front perspective view of the seat assembly of FIG. 5 with an airbag assembly received in a raceway defined between rear carrier module and seatback frame;

FIG. 7 is a rear perspective view of the seat assembly of FIG. 2 with a rear carrier module removed therefrom to reveal the front carrier module and the seatback frame;

FIG. 8 is a rear perspective exploded view of a seatback assembly;

FIGS. 9A-9C are cross-sectional views of the seatback assembly of FIG. 2 taken at line IX;

FIG. 10 is a front perspective view of a passenger seated in the seat assembly of FIG. 2 with an overhead airbag shown in a deployed position;

FIG. 11 is a rear perspective view of the seat assembly and passenger of FIG. 10;

FIG. 12 is a top front perspective view of the seat assembly and passenger of FIG. 10;

FIG. 13 is a front perspective exploded view of a seatback assembly having an intermediate carrier module; and

FIG. 14 is a cross-sectional perspective view of the seatback assembly of FIG. 13 as assembled.

### DETAILED DESCRIPTION OF THE PREFERRED EMBODIMENTS

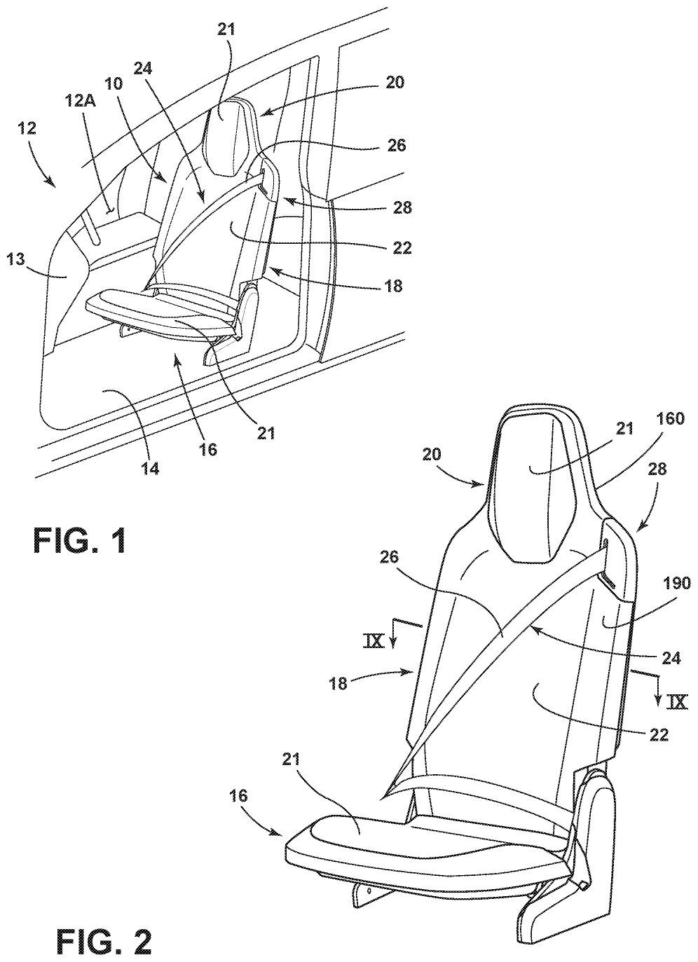

For purposes of description herein, the terms “upper,” “lower,” “right,” “left,” “rear,” “front,” “vertical,” “horizontal,” and derivatives thereof shall relate to the seat assembly as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to FIG. 1, a seat assembly 10 is shown disposed within an interior 12A of a vehicle 12. Specifically, the seat assembly 10 is disposed within the vehicle interior 12A adjacent to an instrument panel or dashboard 13. In FIG. 1, the seat assembly 10 is positioned in a driver's side seating area. However, it is contemplated that the seat assembly 10, or various components and features thereof, can be disposed on other seat assemblies positioned in other areas of a vehicle interior 12A, such as the passenger side seating area, a rear seating area, or a third row seating option for example. The seat assembly 10 is shown in FIG. 1 as being supported on a vehicle floor support surface 14 and generally includes a substantially horizontal seat portion 16 and a substantially upright seatback assembly 18. It is contemplated that the seat assembly 10 may also be supported on a track system for providing fore and aft movement within the vehicle interior 12A. It is contemplated that the seatback assembly 18 may be a pivoting member configured for reclining movement relative to the seat portion 16. It is further contemplated that the seat assembly 10 may rotate within the vehicle interior between forward-facing and rearward-facing orientations. As such, it is contemplated that the vehicle 12 may be an autonomous or self-driving vehicle, in which a seat assembly having forward-facing and rearward-facing capabilities may be disposed.

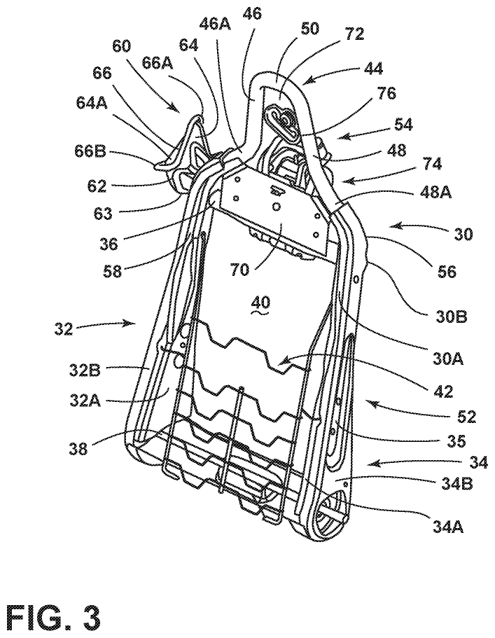

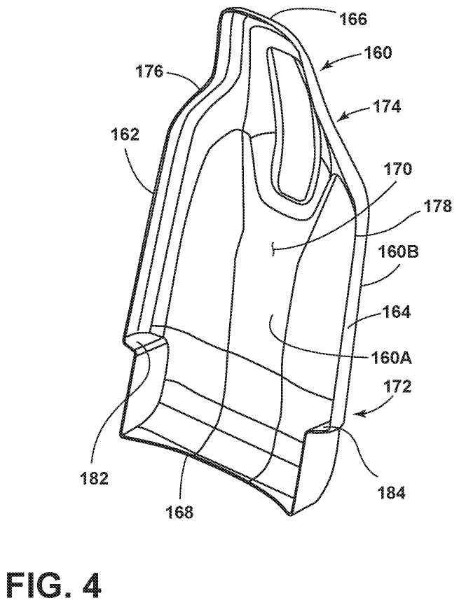

As shown in FIGS. 1 and 2, a headrest assembly 20 is disposed on an upper portion of the seatback assembly 18 and includes a forwardly extending headrest bun 21. The headrest assembly 20 and the seatback assembly 18 may be integrated components or modular components coupled to one another. As further shown in FIG. 1, the various parts of the seat portion 16 and the seatback assembly 18 are covered with seat covers 21, 22, respectively. With specific regard to the seat cover 22 of the seatback assembly 18, the seat cover 22 is contemplated to cover various support materials, such as cloth and foam materials packaged as an exterior comfort carrier module, or font carrier module 190. In assembly, the front carrier module 190 is used to cover various frame materials supporting the seat assembly 10, as well as cover other components of the seat assembly 10, as further described below. It is contemplated that the headrest assembly 20 may be an integrated feature of the front carrier module 190. In assembly, the front carrier module 190 is coupled to a rear carrier module 160 around a seatback frame 30 (FIG. 3) in a partially detachable manner, as further described below.

As further shown in FIGS. 1 and 2, the seat assembly 10 includes a restraint system 24 having a seatbelt 26 with a belt guide 28 disposed at a shoulder height location along the seatback assembly 18. The restraint system 24 of the present concept provides a seat occupant with a familiar restraining system using the seatbelt 26. However, the restraint system 24 is fully integrated into the seat assembly 10, such that the restraint system 24 does not require support or attachment features positioned within the vehicle interior 12A outside of the seat assembly 12, such as a standard B-column belt attachment location. In this way, the seat assembly 10 can alternate between forward-facing and rearward-facing configurations while still providing a consistent mechanism for passenger restraint in the integrated restraint system 24.

Referring now to FIG. 3, a seatback frame 30 is shown having a generally inverted U-shaped configuration with a front side 30A and a rear side 30B. The seatback frame 30 includes first and second side members 32, 34 which are generally disposed in an upright orientation and spaced-apart from one another. Upper and lower cross members 36, 38 interconnect the first and second side members 32, 34 of the seatback frame 30 to define a generally centrally disposed window 40 therebetween. Within the centrally disposed window 40, a suspension system 42 is disposed interconnecting the first and second side members 32, 34. The first and second side members 32, 34 each comprise inner and outer frame members 32A, 34A and 32B, 34B, respectively. The outer frame members 32B, 34B each include inset portions 35 which inwardly extend laterally into the first and second side members 32, 34. The first and second side members 32, 34 are contemplated to be mirror images of one another, such that the description of one side member also describes the other side member in a mirrored configuration. Together, the first and second side members 32, 34 define a back support portion 52 of the seatback frame 30.

As further shown in FIG. 3, an upper frame member 44 includes first and second side portions 46, 48 that interconnect with the first and second side members 32, 34 of the seatback frame 30. Specifically, the first and second side portions 46, 48 of the upper frame member 44 include opposing ends 46A, 48A, respectively, which interconnect with upper portions of the first and second side members 32, 34 of the seatback frame 30. The upper frame member 44 further includes an upper portion 50 which interconnects the first and second side portions 46, 48 to define a headrest support portion 54 of the seatback frame 30. Thus, the first and second side portions 46, 48 upwardly extend from the first and second side members 32, 34, of the seatback frame 30, and then interconnect at upper portion 50 to generally define an overall inverted U-shaped configuration for the upper frame member 44. It is contemplated that the upper frame member 44 may be a unitary member interconnecting the upper portions of the first and second side members 32, 34 of the seatback frame 30.

As further shown in FIG. 3, the headrest support portion 54 of the seatback frame 30 is disposed above the back support portion 52 of the seatback frame 30. Collectively, the first and second side members 32, 34 and the upper frame member 44 cooperate to define an outer perimeter 56 of the seatback frame 30. The outer perimeter 56 of the seatback frame 30 extends around the first side member 32, around and over the upper frame member 44, and around the second side member 34 in a generally inverted U-shaped configuration. Further, the seatback frame 30 also includes an inner edge 58 which is defined by inner portions of the first and second side members 32, 34 and the upper frame member 44. As used herein, the term “inverted U-shaped configuration” is used to describe a structural configuration in which two parallel or substantially parallel side members are interconnected at upper portions thereof by an interconnecting member. The interconnecting member can be a straight member or an upwardly curved member (or portion of a unitary member) that interconnects the side members. A component of the present disclosure described herein as having an inverted U-shaped configuration or a generally/substantially inverted U-shaped configuration may be comprised of multiple components to define an overall inverted U-shaped configuration, or may be a unitary monolithic part disposed in an inverted U-shaped configuration.

With further reference to FIG. 3, the seatback frame 30 includes a seatbelt retainer 60 having a mounting bracket 62 which is coupled to the first side member 32 of the seatback frame 30 in the embodiment shown in FIG. 3. Specifically, the mounting bracket 62 is coupled to the outer frame member 32B of the first side member 32 at a mounting portion 63 of the mounting bracket 62. The mounting bracket 62 further includes a plate portion 64 which outwardly extends from the mounting portion 63, such that, in an overall sense, the mounting bracket 62 outwardly extends from the outer perimeter 56 of the seatback frame 30 at the first side member 32 thereof. The plate portion 64 of the mounting bracket 62 supports a retaining bar 66 thereon. The retaining bar 66 is shown in FIG. 3 in the form of a bar or tube that is outwardly extending in a forward manner from a front side 64A of the plate portion 64 of the mounting bracket 62. The retaining bar 66 includes first and second ends 66A, 66B which are coupled to the plate portion 64 of the mounting bracket 62, such that a portion of the retaining bar 66 is spaced-apart from the plate portion 64 of the mounting bracket 62 for receiving a seatbelt and guiding the same therethrough and around the retaining bar 66. In use, the seatbelt retainer 60 is configured to route a seatbelt of a seatbelt mechanism around a seat occupant, in a manner shown with respect to the seatbelt 26 illustrated in FIG. 1. In the embodiment of FIG. 3, the seatbelt retainer 60 is shown disposed on the first side member 32 of the seatback frame 30, however, it is also contemplated that the seatbelt retainer 60 may be disposed on the second side member 34 of the seatback frame 30 to provide a seat assembly configured much like the seat assembly 10 shown in FIGS. 1 and 2. As such, it is contemplated that the seatback frame 30 shown in FIG. 3 may be used as a passenger side seat assembly to provide for a crossing seatbelt configuration similar to a standard seatbelt configuration found in a car having non-rotating seat assemblies.

As further shown in FIG. 3, a mounting plate 70 is coupled to the upper cross member 36 of the seatback frame 30, and is further coupled to the upper frame member 44. The mounting plate 70 is provided add structural support to the seatback frame 30 and to support components of the seat assembly 10, such as a seatbelt retractor mechanism 74. Another mounting plate 72 is shown disposed above mounting plate 70 on the upper frame member 44 between the first and second side portions 46, 48 thereof. In the embodiment shown in FIG. 3, the mounting plate 72 includes a retaining bar 76 mounted thereto which may be used to guide a seatbelt through the seat assembly 10, such as seatbelt 26 shown in FIGS. 1 and 2.

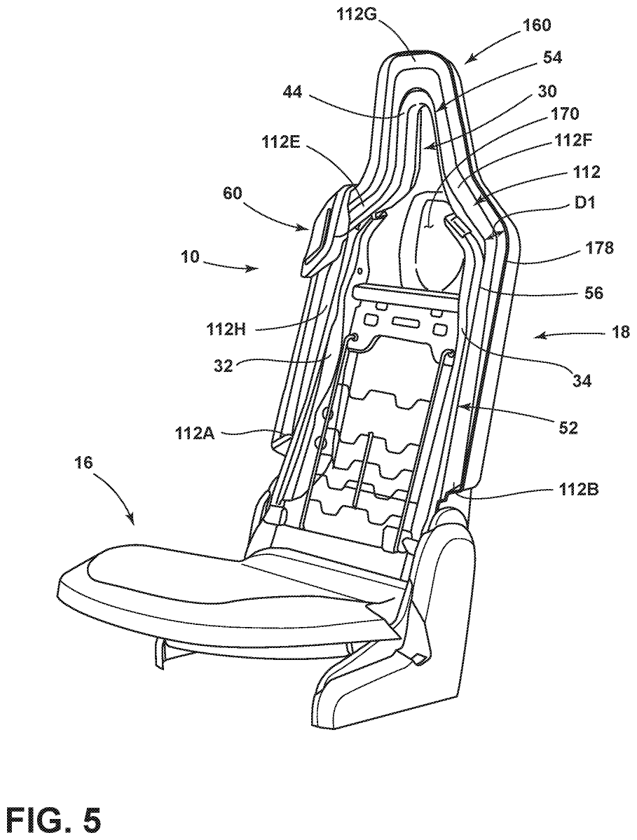

Referring now to FIG. 4, the rear carrier module 160 is shown from a front perspective view and is contemplated to be a rear closure panel for enclosing the seatback frame 30 when coupled to the front carrier assembly 190. The rear carrier module 160 includes a front side 160A and a rear side 160B. The rear carrier module 160 includes first and second sides 162, 164 which are interconnected by an upper portion 166 and a lower portion 168 to define a rearwardly extending cavity 170. The cavity 170 includes a back support portion 172 and a headrest support portion 174 which is disposed above the back support portion 172. In assembly, the headrest support portion 54 of the seatback frame 30 is received in the headrest support portion 174 of the rear carrier module 160. Similarly, the back support portion 52 of the seatback frame 30 is received in the back support portion 172 of the rear carrier module 160 in assembly. The rear carrier module 160 includes an outer perimeter 176 and a front edge 178, wherein the cavity 170 rearwardly extends from the front edge 178 of the rear carrier module 160. At the front edge 178, the front carrier module 160 is coupled to a rear edge of the front carrier module 190 around the frame assembly 30. The rear carrier module 160 further includes first and second landings 182, 184 disposed near lower portions of the first and second sides 162, 164. The first and second landings 182, 184 inwardly extend from the first and second sides 162, 164, respectively, to provide a substantially horizontal surface for supporting an airbag assembly 150, as further described below. It is contemplated that the rear carrier module 160 is a unitary member formed as a monolithic carrier member. It is further contemplated that the rear carrier module 160 may be comprised of a substantially rigid polymeric material formed in a suitable injection molding process.

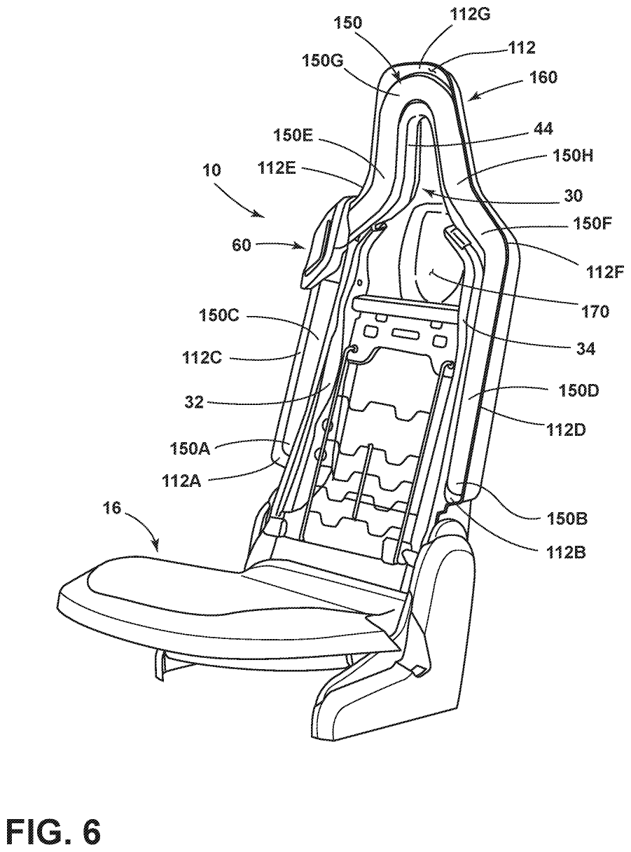

Referring now to FIG. 5, the seat assembly 10 is shown with the front carrier module 190 removed from the seatback assembly 18 to reveal the seatback frame 30 as positioned within the cavity 170 of the rear carrier module 160. As shown in FIG. 5, the outer perimeter 56 of the seatback frame 30 is disposed at an inset position relative to the front edge 178 of the rear carrier module 160. With the outer perimeter 56 of the seatback frame 30 being inset from the front edge 178 of the rear carrier module 160, a raceway 112 is defined therebetween. Specifically, the raceway 112 is a forwardly opening raceway for receiving an airbag assembly in the spacing between the outer perimeter 56 of the seatback frame 30 and the front edge 178 of the rear carrier module 160. As specifically shown in FIG. 5, the front edge 178 of the rear carrier module 160 is spaced-apart from the outer perimeter 56 of the seatback frame 30 a distance D1. With the front edge 178 of the rear carrier module 160 is spaced outwardly from the outer perimeter 56 of the seatback frame 30, the raceway 112 includes an inverted U-shaped configuration that surrounds the outer perimeter 56 of the seatback frame 30. In this way, an airbag assembly can be disposed in the raceway 112 around the entirety of the seatback frame 30, including the back support portion 52 and the headrest support portion 54 thereof to provide for an overhead airbag assembly.

With further reference to FIG. 5, the raceway 112 defined between the seatback frame 30 and the rear carrier module 160 is configured to substantially span an entire length around the outer perimeter 56 of the seatback frame 30. In this way, the raceway 112 can support an airbag assembly which substantially follows the contours of the seatback frame 30 for an entire length or a portion of the length of the raceway 112, as further described below. As shown in FIG. 5, the raceway 112 includes first and second ends 112A, 112B with first and second upwardly extending portions 112C, 112D of the raceway 112 extending upwardly from the first and second ends 112A, 112B of the raceway 112, respectively. At a general shoulder height position, the raceway 112 includes inwardly extending portions 112E, 112F, which further culminate at an upper transverse portion 112G. Collectively, the portions 112C, 112D, 112E, 112F, and 112G of the raceway 112 disposed between the first and second ends 112A, 112B of the raceway 112 define a body portion 112H of the raceway 112 having an inverted U-shaped configuration.

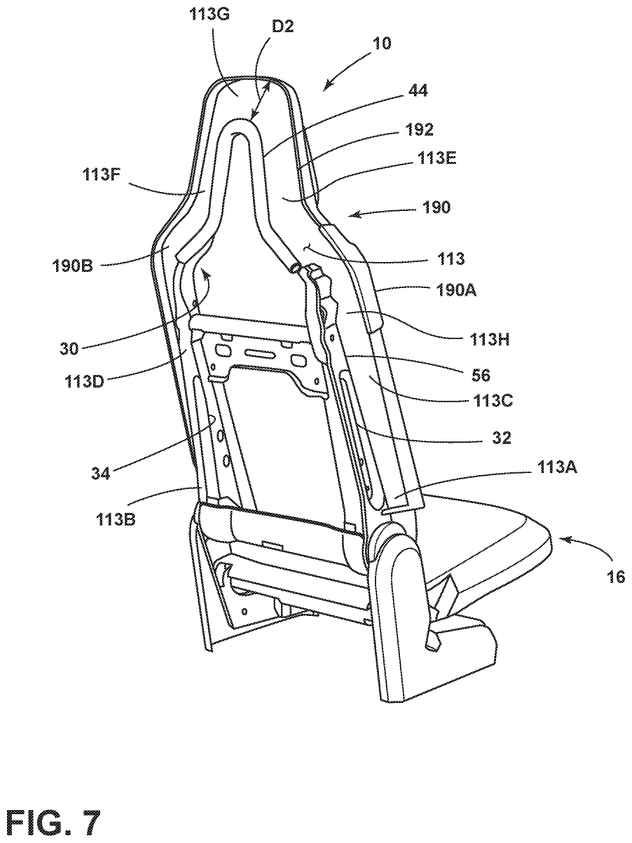

Referring now to FIG. 6, an airbag assembly 150 is shown disposed within the raceway 112 defined between the outer perimeter 56 of the seatback frame 30 and the front edge 178 of the rear carrier module 160. The airbag assembly 150 includes first and second ends 150A, 150B which further include upwardly extending portions 150C, 150D, respectively. The airbag assembly 150 includes inwardly extending portions 150E, 150F, which further culminate at an upper transverse portion 150G. Collectively, the portions 150C, 150D, 150E, 150F, and 150G of the airbag assembly 150 disposed between the first and second ends 150A, 150B define an elongate body portion 150H of the airbag assembly 150, such that the airbag assembly 150 is an elongate member having an inverted U-shaped configuration. In this way, the body portion 150H of the airbag assembly 150 extends all the way around the seatback frame 30 as received in the raceway 112. It is contemplated that the airbag assembly 150 is a flexible member, such that the body portion 150H of the airbag assembly 150 can be contoured to fit within the raceway 112. Thus, it is contemplated that the inverted U-shaped configuration of the airbag assembly 150 is provided by the airbag assembly 150 being stowed within the raceway 112 which includes a substantially rigid U-shaped configuration to receive and support the airbag assembly 150.

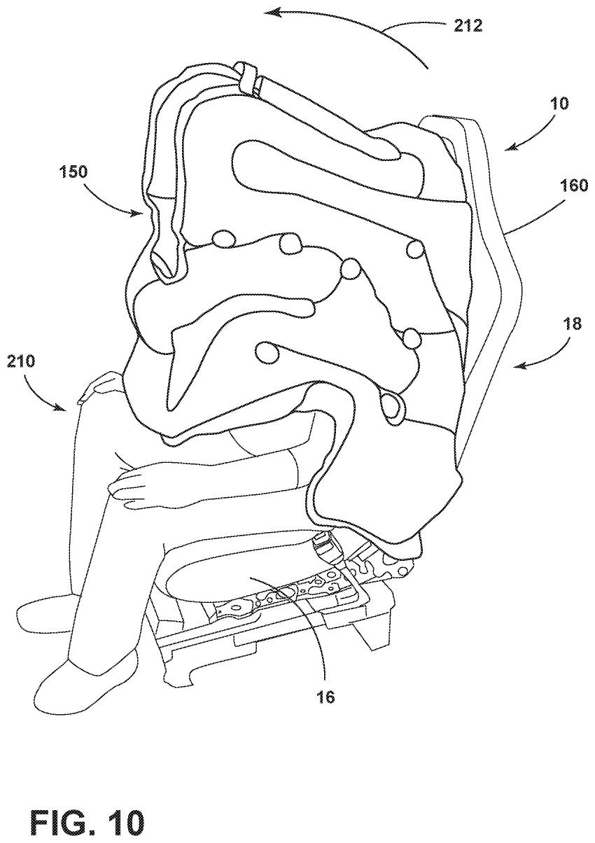

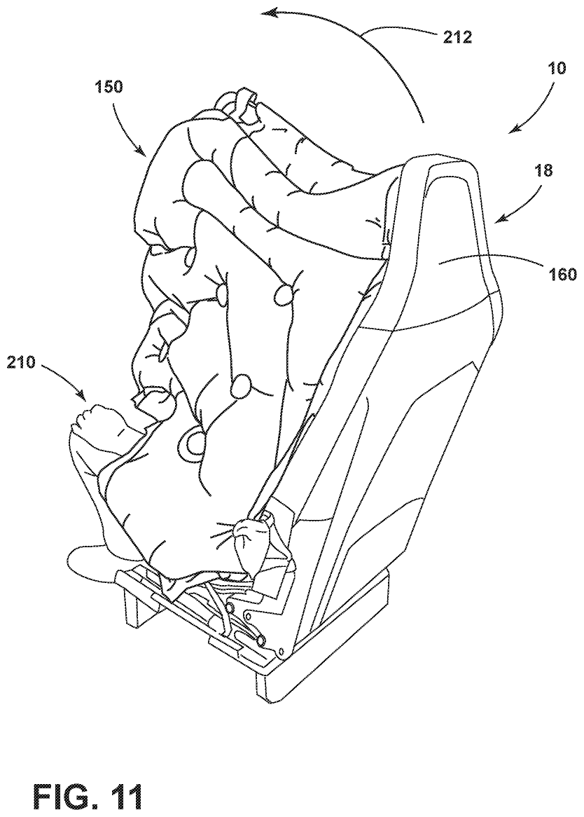

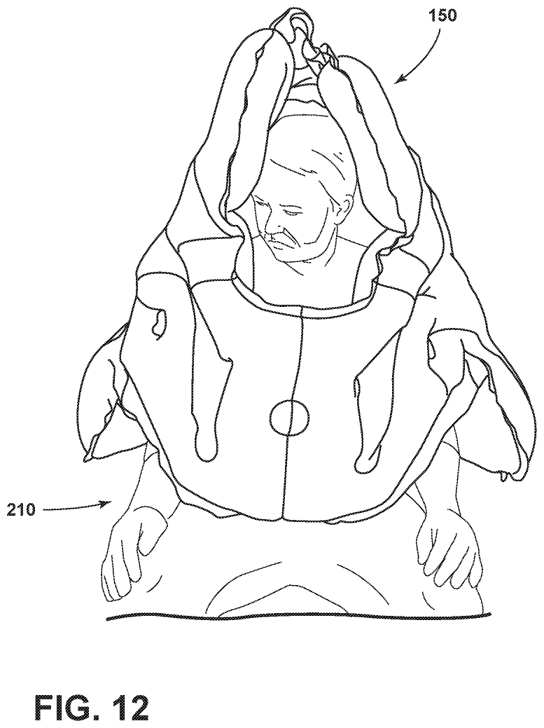

As further shown in FIG. 6, the portions 150C, 150D, 150E, 150F, and 150G of the body portion 150H of the airbag assembly 150 are shown aligned with the portions 112C, 112D, 112E, 112F, and 112G of the body portion 112H of the raceway 112. As further shown in FIG. 5C, the first and second ends 150A, 150B of the airbag assembly 150 are shown received in the raceway 112 at the first and second ends 112A, 112B of the raceway 112. In this way, the airbag assembly 150 extends along an entire length of the raceway 112 between the first and second ends 112A, 112B. It is contemplated that the airbag assembly 150 may be disposed partially along the length of the raceway 112, however, the airbag assembly 150 of the present concept is provided to surround the entire seatback assembly 18 at an outer portion thereof, such that the airbag assembly 150 of the present concept is an overhead airbag assembly that surrounds the arms, torso and head of a seat occupant as seated within the seat assembly 10. This surround configuration of the airbag assembly 150 relative to a seat occupant is further illustrated in FIGS. 10-12 described below.

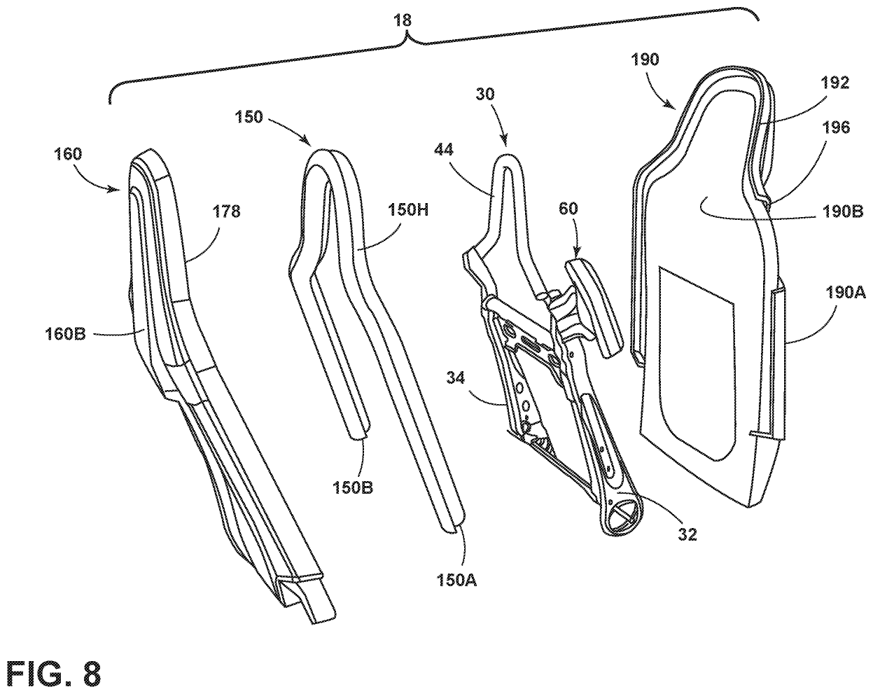

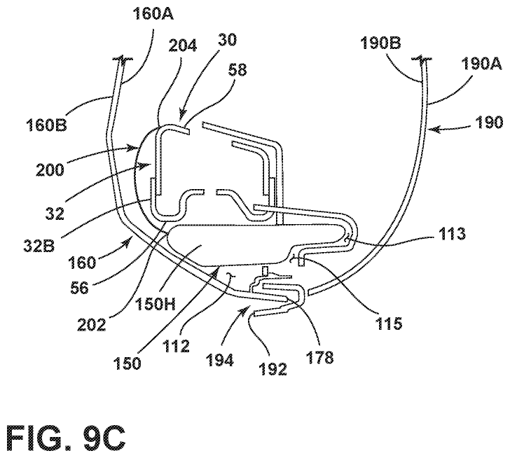

Referring now to FIG. 7, the seat assembly 10 is shown with the rear carrier module 160 removed from the seatback assembly 18 to reveal the seatback frame 30 as positioned relative to the front carrier module 190. The front carrier module 190 includes a front side 190A and a rear side 190B. As shown in FIG. 7, the outer perimeter 56 of the seatback frame 30 is disposed at an inset position relative to a rear edge 192 of the front carrier module 190. Specifically, the rear edge 192 of the front carrier module 190 is spaced-apart outwardly from the outer perimeter 56 of the seatback frame 30 a distance D2. This spacing between the outer perimeter 56 of the seatback frame 30 and the rear edge 192 of the front carrier module 190 defines a raceway 113 therebetween. The raceway 113 is contemplated to be a complementary raceway to raceway 112 described above. As such, the raceway 113 includes first and second ends 113A, 113B with first and second upwardly extending portions 113C, 113D of the raceway 113 extending upwardly from the first and second ends 113A, 113B of the raceway 113, respectively. The raceway 113 further includes inwardly extending portions 113E, 113F, which further culminate at an upper transverse portion 113G. Collectively, the portions 113C, 113D, 113E, 113F, and 113G of the raceway 113 disposed between the first and second ends 113A, 113B of the raceway 113 define a body portion 113H of the raceway 113 having an inverted U-shaped configuration. Thus, it is contemplated that when the front edge 178 of the rear carrier module 160 is coupled to the rear edge 192 of the front carrier module 190, the airbag assembly 150 disposed within the raceway 112 defined between the front edge 178 of the rear carrier module 160 and the outer perimeter 56 of the seatback frame 30 may extend outwardly into the raceway 113 defined between the rear edge 192 of the front carrier module 190 and the outer perimeter 56 of the seatback frame 30. As such, the raceways 112, 113 may combine to provide a common raceway 115 (FIGS. 9A and 9B) for supporting the airbag assembly 150 therein.

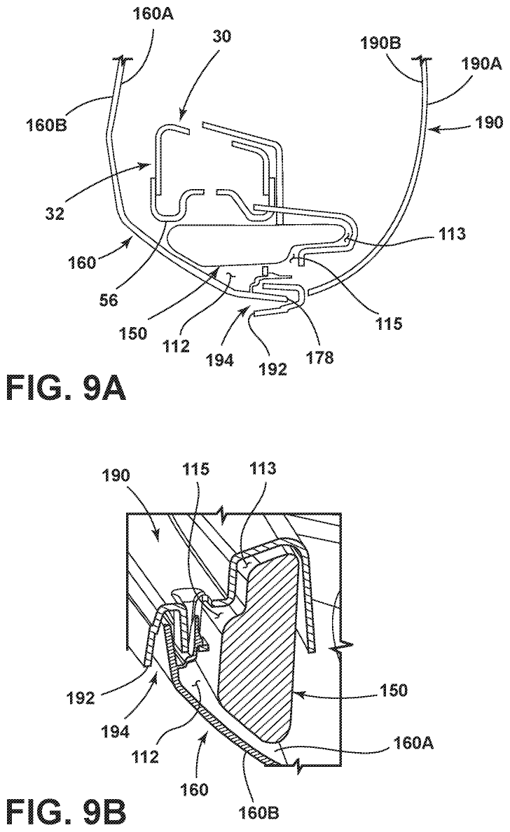

Referring now to FIG. 8, the seatback assembly 18 is shown in an exploded view with the rear carrier module 160 exploded away from the seatback frame 30 with the airbag assembly 150 disposed therebetween. As further shown in FIG. 8, the front carrier module 190 is also exploded away from the seatback frame 30. As further shown in FIG. 8, the front carrier module 190 includes an access aperture 196 disposed at a shoulder height portion thereof. In assembly, the seatbelt retainer 60 is configured to pass through the access aperture 196 when the rear edge 192 of the front carrier module 190 is coupled around the frame assembly 30 to the front edge 178 of the rear carrier module 160. In this way, the seatbelt retainer 60 can function to guide a seatbelt of the seat assembly 10 without impeding the deployment of the airbag assembly 150.

Referring now to FIGS. 9A and 9B, the front carrier module 190 is shown coupled to the rear carrier module 160 around the seatback frame 30. The raceway 112 is shown as defined between the front edge 178 of the rear carrier module 160 and the outer perimeter 56 of the seatback frame 30. Similarly, in the configuration shown in FIG. 9A, the raceway 113 is shown as defined between the rear edge 192 of the front carrier module 190 and the outer perimeter 56 of the seatback frame 30. In this way, the common raceway 115 is defined by the combination of raceways 112, 113. The airbag assembly 150 is shown as disposed within the common raceway 115. As positioned in FIG. 9A, the airbag assembly 150 is substantially disposed within raceway 112 and partially disposed within raceway 113. As further shown in FIG. 9A, the front edge 178 of the rear carrier module 160 is operably coupled to rear edge 192 of the front carrier module 190 to form a seam or joint 194 therebetween. It is contemplated that the airbag assembly 150 will separate the front carrier module 190 and the rear carrier module 160 at the junctions defined by the joint 194 between the front carrier module 190 and the rear carrier module 160 to deploy in a forward direction around a seat occupant in a manner as shown in FIGS. 10-12.

Referring now to FIG. 9C, the airbag assembly 150 is again shown disposed within the common raceway 115 defined by raceways 112, 113. In the embodiment shown in FIG. 9C, the airbag assembly 150 includes a strap 200 which outwardly extends from the body portion 150H of the airbag assembly 150 at a first end 202 of the strap 200. The strap 200 further includes a second end 204 which is operably coupled to the inner edge 58 of the seatback frame 30, such that the strap 200 wraps around the rear side 30B of the seatback frame 30. It is further contemplated that the airbag assembly 150 may include a plurality of straps for mounting the airbag assembly 150 to the seatback frame 30. As such, it is contemplated that the straps 200 of the plurality of straps of the of the airbag assembly 150 may be evenly spaced-apart along portions of the body portion 150H of the airbag assembly 150 for securely mounting the airbag assembly 150 to the seatback frame 30. Such a configuration of mounting the airbag assembly 150 to the seatback frame 30 provides for a reinforcing configuration against a seat occupant whom can impart a forwardly directed force on the airbag assembly 150 after the airbag assembly 150 has been deployed. The straps 200 help to redirect such forces.

Referring now to FIGS. 10-12, a seat occupant 210 is shown seated on the seat assembly 10. In FIGS. 10-12, the airbag assembly 150 is shown in the deployed position. With the airbag assembly 150 being and overhead airbag assembly disposed around the seatback assembly 18, the airbag assembly 150 is configured to deploy outwardly along the path as indicated by arrow 212 to surround the seat occupant 210 as shown in FIGS. 10-12.

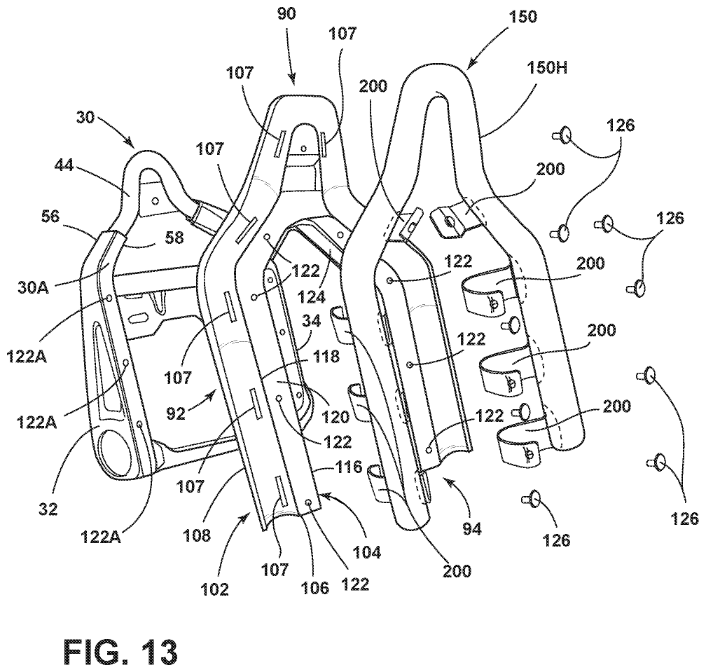

Referring now to FIG. 13, it is contemplated that an intermediate carrier member 90 may be used with the present concept to augment the support for the deployment of the airbag assembly 150. In FIG. 13, the intermediate carrier module 90 is configured to couple to the front side 30A of the seatback frame 30. The intermediate carrier module 90 includes a cradle portion 102 and a mounting portion 104. The cradle portion 102 includes an inner edge 106 and an outer edge 108 with a rearwardly extending body portion 110 disposed therebetween. It is contemplated that the rearwardly extending body portion 110 may be a curved rearwardly extending body portion for receiving the airbag assembly 150 therein.

As further shown in FIG. 13, the mounting portion 104 of the intermediate carrier module 90 is disposed inboard of the cradle portion 102 of the intermediate carrier module 90. In the embodiment shown in FIG. 13, the mounting portion 104 of the intermediate carrier module 90 includes an inner edge 116 and an outer edge 118 with a body portion 120 disposed therebetween. The mounting portion 104 further includes a rearwardly extending sidewall 124 which extends rearwardly from the inner edge 116 of the mounting portion 104. In use, the rearwardly extending sidewall 124 is configured to cooperate with the body portion 120 of the mounting portion 104 to define an L-shaped cross-section which wraps around the inner edge 58 of the seatback frame 30. The body portion 120 of the mounting portion 104 further includes mounting apertures 122 disposed therethrough which are configured to align with mounting apertures 122A disposed on the front side 30A of the seatback frame 30. Fasteners 126 are used to couple the intermediate carrier module 90 to the front side 30A of the seatback frame 30 at respective mounting apertures 122, 122A. In this way, the mounting portion 104 of the intermediate carrier module 90 is configured to securely couple the intermediate carrier module 90 to the seatback frame 30.

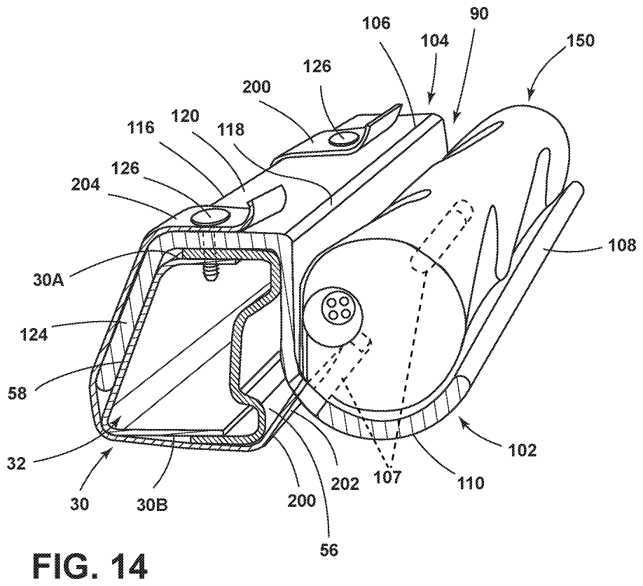

As further shown in FIG. 13, the body portion 110 of the cradle portion 102 includes a plurality of slots 107 disposed therethrough that are spaced-apart along the body portion 110. In FIG. 13, the airbag assembly 150 includes a plurality of straps 200 extending outwardly from the body portion 150H of the airbag assembly 150. In assembly, the straps 200 are configured to be inserted through the slots 107 for coupling the airbag assembly 150 to the frame assembly 30 using the fasteners 126 and respective mounting apertures 122, 122A as shown in FIG. 14. In this way, the mounting portion 104 covers the front side 30A of the seatback frame 30, while the straps 200 wrap around the rear side 30B of the seatback frame 30.

Referring now to FIG. 14, the intermediate carrier module 90 is shown as being coupled to the seatback frame 30. The straps 200 are shown as being inserted through the slots 107 of the body portion 110 of the cradle portion 102 of the intermediate carrier module 90 and wrap around the rear side 30B of the seatback frame 30. The straps 200 are secured to both the body portion 120 of the mounting portion 104 of the intermediate carrier module 90 and the front side 30A of the seatback frame assembly 30 via fasteners 126. Further, the rearwardly extending sidewall 124 of the mounting portion 102 of the intermediate carrier module 90 is wrapped around the inner edge 58 of the seatback frame member 30. In this way, the seatback assembly 18 is secured against reward forces imparted by the airbag assembly 150 during deployment and forward forces of a seat occupant on the airbag assembly 150 after deployment.

According to one aspect of the present invention, a seatback assembly includes a seatback frame that has first and second side members defining a back support portion of the seatback frame. An upper frame member interconnects the first and second side members of the seatback frame to define a headrest support portion of the seatback frame. The seatback frame includes an outer perimeter disposed around the first and second side members and the upper frame member. A front carrier module is operably coupled to the seatback frame. A rear carrier module is operably coupled to the seatback frame. The rear carrier module and the front carrier module are operably coupled to one another around the seatback frame. The outer perimeter of the seatback frame is inset from a front edge of the rear carrier module to define a raceway therebetween. An airbag assembly is received in the raceway for outward deployment therefrom. The airbag assembly is an elongate member disposed on opposed sides of the back support portion of the seatback frame. The airbag assembly is disposed over the headrest support portion of the seatback frame.

Embodiments of the first aspect of the invention can include any one or a combination of the following features:
the raceway includes first and second ends with a body portion disposed therebetween;
the body portion of the raceway includes first and second upwardly extending portions which respectively extend upwardly from the first and second ends of the raceway adjacent the first and second side members of the seatback frame;
the body portion of the raceway further includes an upper transverse portion which interconnects the first and second upwardly extending portions of the raceway;
the airbag assembly includes first and second ends with a body portion disposed therebetween;
the first and second ends of the airbag assembly are received in the first and second ends of the raceway;
the body portion of the airbag assembly is disposed along the body portion of the raceway between the first and second ends of the raceway; and
the body portion of the raceway includes a substantially inverted U-shaped configuration.

According to another aspect of the present invention, a seatback assembly includes a seatback frame that has an upper portion and an outer perimeter. A rear carrier module is operably coupled to the seatback frame. The rear carrier module includes a front edge outwardly spaced-apart from the outer perimeter of the seatback frame and surrounding the outer perimeter of the seatback frame to define a raceway. An airbag assembly is received in the raceway. The airbag assembly is an elongate airbag assembly having first and second ends with a body portion disposed between the first and second ends. The body portion of the airbag assembly is positioned over the upper portion of the seatback frame.

Embodiments of the second aspect of the invention can include any one or a combination of the following features:
the airbag assembly is positioned over an entirety of the upper portion of the seatback frame along the outer perimeter of the seatback frame;
the raceway includes first and second ends with a body portion disposed therebetween;
the first and second ends of the airbag assembly are received in the first and second ends of the raceway;
the airbag assembly includes at least one strap outwardly extending from the body portion of the airbag assembly;
the at least one strap interconnects the airbag assembly with the seatback frame; and
the at least one strap includes a plurality of straps spaced-apart along the body portion of the airbag assembly.

According to yet another aspect of the present invention, a seatback assembly includes a seatback frame having an outer perimeter. A front carrier module is operably coupled to the seatback frame and includes a rear edge. A rear carrier module is operably coupled to the seatback frame and includes a front edge. The rear carrier module and the front carrier module are detachably coupled to one another at the respective front and rear edges. The outer perimeter of the seatback frame is inset from the respective front and rear edges of the rear carrier module and the front carrier module to define a raceway therebetween. An airbag assembly is received in the raceway for outward deployment through a seam defined along a junction of the respective front and rear edges of the rear carrier module and the front carrier module.

Embodiments of the third aspect of the invention can include any one or a combination of the following features:
the seatback frame includes an upwardly extending headrest support portion supporting a headrest assembly thereon;
the airbag assembly is an elongate member disposed over the headrest assembly;
airbag assembly is disposed in an inverted U-shaped configuration; and
airbag assembly operable between stowed and deployed conditions, and further wherein the airbag assembly projects forward around the front carrier module in the deployed condition.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A seatback assembly, comprising:
a seatback frame having first and second side members defining a back support portion of the seatback frame, and an upper frame member interconnecting the first and second side members of the seatback frame to define a headrest support portion of the seatback frame, wherein the seatback frame includes an outer perimeter disposed around the first and second side members and the upper frame member;
a front carrier module operably coupled to the seatback frame;
a rear carrier module operably coupled to the seatback frame, wherein the rear carrier module and the front carrier module are operably coupled to one another around the seatback frame, and further wherein the outer perimeter of the seatback frame is inset from a front edge of the rear carrier module to define a raceway therebetween; and
an airbag assembly received in the raceway for outward deployment therefrom, wherein the airbag assembly is an elongate member disposed on opposed sides of the back support portion of the seatback frame, and further wherein the airbag assembly is disposed over the headrest support portion of the seatback frame.

2. The seatback assembly of claim 1, wherein the raceway includes first and second ends with a body portion disposed therebetween.

3. The seatback assembly of claim 2, wherein the body portion of the raceway includes first and second upwardly extending portions which respectively extend upwardly from the first and second ends of the raceway adjacent the first and second side members of the seatback frame.

4. The seatback assembly of claim 3, wherein the body portion of the raceway further includes an upper transverse portion which interconnects the first and second upwardly extending portions of the raceway.

5. The seatback assembly of claim 4, wherein the airbag assembly includes first and second ends with a body portion disposed therebetween.

6. The seatback assembly of claim 5, further wherein the first and second ends of the airbag assembly are received in the first and second ends of the raceway.

7. The seatback assembly of claim 6, wherein the body portion of the airbag assembly is disposed along the body portion of the raceway between the first and second ends of the raceway.

8. The seatback assembly of claim 7, wherein the body portion of the raceway includes a substantially inverted U-shaped configuration.

9. A seatback assembly, comprising;
a seatback frame having an upper portion and an outer perimeter;
a rear carrier module operably coupled to the seatback frame, wherein the rear carrier module includes a front edge outwardly spaced-apart from the outer perimeter of the seatback frame and surrounding the outer perimeter of the seatback frame to define a raceway therebetween; and
an airbag assembly received in the raceway, wherein the airbag assembly is an elongate airbag assembly having first and second ends with a body portion disposed between the first and second ends, and further wherein the body portion of the airbag assembly is positioned over the upper portion of the seatback frame.

10. The seatback assembly of claim 9, wherein the airbag assembly is positioned over an entirety of the upper portion of the seatback frame along the outer perimeter of the seatback frame.

11. The seatback assembly of claim 9, wherein the raceway includes first and second ends with a body portion disposed therebetween.

12. The seatback assembly of claim 11, wherein the first and second ends of the airbag assembly are received in the first and second ends of the raceway.

13. The seatback assembly of claim 9, wherein the airbag assembly includes at least one strap outwardly extending from the body portion of the airbag assembly.

14. The seatback assembly of claim 13, wherein the at least one strap interconnects the airbag assembly with the seatback frame.

15. The seatback assembly of claim 14, wherein the at least one strap includes a plurality of straps spaced-apart along the body portion of the airbag assembly.

16. A seatback assembly, comprising:
a seatback frame having an outer perimeter;
a front carrier module operably coupled to the seatback frame and having a rear edge;
a rear carrier module operably coupled to the seatback frame and having a front edge, wherein the rear carrier module and the front carrier module are detachably coupled to one another at the respective front and rear edges thereof, and further wherein the outer perimeter of the seatback frame is inset from the respective front and rear edges of the rear carrier module and the front carrier module to define a raceway therebetween; and
an airbag assembly received in the raceway for outward deployment through a seam defined along a junction of the respective front and rear edges of the rear carrier module and the front carrier module.

17. The seatback assembly of claim 16, wherein the seatback frame includes an upwardly extending headrest support portion supporting a headrest assembly thereon.

18. The seatback assembly of claim 17, wherein the airbag assembly is an elongate member disposed over the headrest assembly.

19. The seatback assembly of claim 18, wherein airbag assembly is disposed in an inverted U-shaped configuration.

20. The seatback assembly of claim 16, wherein airbag assembly operable between stowed and deployed conditions, and further wherein the airbag assembly projects forward around the front carrier module in the deployed condition.
